(19) United States
(12) Patent Application Publication
(10) Pub. No.: US 2011/0155707 A1
(43) Pub. Date: Jun. 30, 2011

(54) LASER SCRIBING APPARATUS AND PROCESS FOR SOLAR PANEL

(75) Inventors: Hsiu-Chi Hsu, Hsinchu City (TW); Chih-Ming Lin, Zhubei City (TW)

(73) Assignee: DU PONT APOLLO LIMITED, Pak Shek Kok, N.T. (HK)

(21) Appl. No.: 12/979,293

(22) Filed: Dec. 27, 2010

Related U.S. Application Data
(60) Provisional application No. 61/291,440, filed on Dec. 31, 2009.

(51) Int. Cl. B23K 26/00

(52) U.S. Cl. 219/121.72; 219/121.67

(57) ABSTRACT

A laser scribing apparatus includes a chamber, a transferring line, a laser head and a pair of air vacuum device and air knife device. The chamber includes an input door and an output door, through which a processing target is input and output respectively. The transferring line is to transfer the processing target through the input door and output door. The laser head is disposed within the chamber. The air vacuum device and air knife device are disposed outside the chamber and adjacent to the input door for cleaning and cooling the processing target.

### RELATED APPLICATIONS

This application claims priority to U.S. Provisional Application Ser. No. 61/291,440, filed Dec. 31, 2009, which is herein incorporated by reference.

### BACKGROUND

1. Field of Invention

The present invention relates to a laser scribing apparatus and process, and more particularly relates to a laser scribing apparatus and process for a solar panel.

2. Description of Related Art

As is well known in the thin-film semiconductor art, photovoltaic cells that convert solar radiation into usable electrical energy can be fabricated by sandwiching certain semiconductor structures, such as the amorphous silicon, between two electrodes. One of the electrodes is typically transparent to permit solar radiation to reach the semiconductor material. This “front” electrode can be comprised of a thin film (i.e., less than 10 micrometers in thickness) of transparent conductive oxide material, such as tin oxide, and usually is formed between a transparent supporting substrate made of glass or plastic and the photovoltaic semiconductor material. The “back” electrode, which is formed on the surface of the semiconductor material opposite the front electrode, generally comprises a thin film of metal such as, for example, aluminum.

The voltage produced across the electrodes of a single photovoltaic cell, however, is insufficient for most applications. To achieve a useful power level from photovoltaic semiconductor devices, individual photovoltaic cells must be electrically connected in series in an array referred to herein as photovoltaic “module.”

The thin-film photovoltaic module is typically manufactured by a deposition and patterning method. Several patterning techniques are conventionally known for forming the grooves separating adjacent photovoltaic cells, including silkscreening with resist masks, etching with positive or negative photoresists, mechanical scribing, electrical discharge scribing, and laser scribing. Laser scribing and silkscreening methods have emerged as practical, cost-effective, high-volume processes for manufacturing thin-film semiconductor devices, including amorphous silicon photovoltaic modules. Laser scribing has an additional advantage over silkscreening because it can separate adjacent cells in a multi-cell device by forming separation grooves having a width less than 25 micrometers, compared to the typical silkscreened groove width of approximately 380-500 micrometers. A photovoltaic module fabricated with laser scribing thus has a larger percentage of its surface area actively engaged in producing electricity and, consequently, has a higher efficiency than a module fabricated by silkscreening.

Since the laser scribing process has a high precision, it may be easily affected by several process conditions, such as particles on the glass substrate or glass substrate distortions due to high temperatures, to result in low yield throughput.

For the forgoing reasons, there is a need for improving the laser scribing apparatus and process for a solar panel.

### SUMMARY

In accordance with an aspect of the present invention, a laser scribing apparatus includes a chamber, a transferring line, a laser head and a first pair of air vacuum device and air knife device. The chamber includes an input door and an output door, through which a processing target is input and output respectively. The transferring line is to transfer the processing target through the input door and output door. The laser head is disposed within the chamber. The first pair of air vacuum device and air knife device are disposed outside the chamber and adjacent to the input door for cleaning and cooling the processing target.

According to one embodiment, the first pair of air vacuum device and air knife device are disposed above the transferring line.

According to another embodiment, the first pair of air vacuum device and air knife device are disposed under the transferring line.

According to another embodiment, the laser scribing apparatus further includes a second pair of air vacuum device and air knife device, wherein the first pair of air vacuum device and air knife device are disposed above the transferring line, and the second pair of air vacuum device and air knife device are disposed under the transferring line.

According to another embodiment, the laser head is disposed above the transferring line.

According to another embodiment, the laser head is disposed under the transferring line.

According to another embodiment, the air knife device is closer to the input door than the air vacuum device is.

According to another embodiment, the air knife device and the air vacuum device are equidistant from the transferring line.

According to another embodiment, the transferring line is disposed aligned with the input door and output door.

According to another embodiment, the transferring line includes a plurality of rollers.

In accordance with another aspect of the present invention, a laser scribing process for the solar panel includes the step of air cleaning and air cooling a solar panel comprising a plurality of photovoltaic cells before performing a laser scribing process on the solar panel.

According to one embodiment, the laser scribing process further includes the step of using a pair of air vacuum device and air knife device for air cleaning and air cooling the solar panel.

According to another embodiment, the laser scribing process further includes the step of using a chamber comprising an input door and an output door, through which the solar panel is input and output respectively, for performing the laser scribing process on the solar panel.

According to another embodiment, the laser scribing process further includes the step of using a transferring line for transferring the solar panel through the input door and output door.

According to another embodiment, the laser scribing process further includes the step of using the air knife device blow air stream along a direction that has an included angle ranging from about 30 degrees to 45 degrees between the direction and the solar panel.

According to another embodiment, the laser scribing process further includes the step of using a first pair of air vacuum device and air knife device disposed above transferring line for air cleaning and air cooling the solar panel; and the step of using a second pair of air vacuum device and air knife device disposed under transferring line for air cleaning and air cooling the solar panel.

According to another embodiment, the laser scribing process further includes the step of using a first pair of air vacuum device and air knife device for air cleaning and air cooling a surface of the solar panel; and the step of using a second pair of air vacuum device and air knife device for air cleaning and air cooling an opposite surface of the solar panel.

According to another embodiment, the laser scribing process further includes the step of using the air knife device to force particles away from the solar pane; and the step of using the air vacuum device to collect the particles.

It is to be understood that both the foregoing general description and the following detailed description are by examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 illustrates a side view of a laser scribing apparatus according to one embodiment of this invention;

FIG. 2 illustrates a side view of a laser scribing apparatus according to another embodiment of this invention;

FIG. 3 illustrates a top view of a laser scribing apparatus with air cleaning function according to one embodiment of this invention;

FIG. 4 illustrates a side view of the laser scribing apparatus as illustrated in FIG. 3;

FIG. 5A illustrates a front view of an air knife assembly according to one embodiment of this invention;

FIG. 5B illustrates a side view of the air knife assembly as illustrated in FIG. 5A;

FIG. 6A illustrates a front view of an air vacuum assembly according to one embodiment of this invention; and

FIG. 6B illustrates a side view of the air vacuum assembly as illustrated in FIG. 6A.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

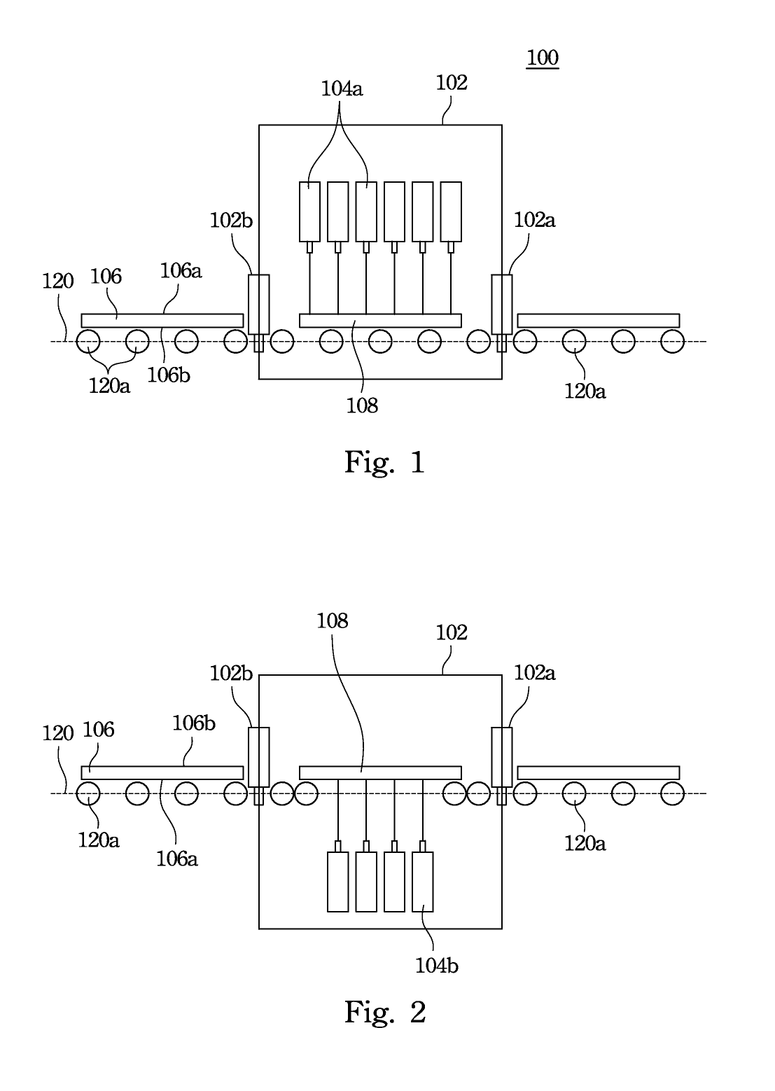

Referring to FIG. 1, which illustrates a side view of a laser scribing apparatus according to one embodiment of this invention. A laser scribing apparatus 100 for processing a solar panel includes a chamber 102, a plurality of laser heads 104a within the chamber 102, an input door 102b and an output door 102a. The input door 102b allows a solar panel, e.g. a solar panel 106, to be input through. The output door 102a allows a solar panel, e.g. a solar panel 108, to be output through. A transferring line 120, i.e. a series of rollers 120a, is to move the solar panel, e.g. 106 or 108, through the input door 102b or the output door 102a. The transferring line 120 is positioned to be aligned with both the input door 102b and the output door 102a such that the solar panel can be moved through the input door 102b or the output door 102a. The solar panel (e.g. 106), which includes a glass substrate, has a surface (e.g. 106b) deposited with thin-film photovoltaic cells thereon and an opposite bare glass surface (e.g. 106a). When the solar panel (e.g. 108) is moved into the chamber 102, the laser heads 104a, positioned above the transferring line, emit laser beams to scribe the thin-film photovoltaic cells through the glass substrate, i.e. the laser beams arrive the bare glass surface first.

Referring to FIG. 2, which illustrates a side view of a laser scribing apparatus according to another embodiment of this invention. The difference between FIG. 2 and FIG. 1 lies in where the laser heads are located. In particular, the laser heads 104b are positioned under the transferring line. With this regard, the solar panel (e.g. 106) is positioned with its bare glass surface (e.g. 106a) facing downwards before the solar panel (e.g. 106) moves into the chamber 102. Therefore, the laser heads 104b, positioned under the transferring line 120, still emit laser beams to scribe the thin-film photovoltaic cells through the glass substrate, i.e. the laser beams arrive the bare glass surface first.

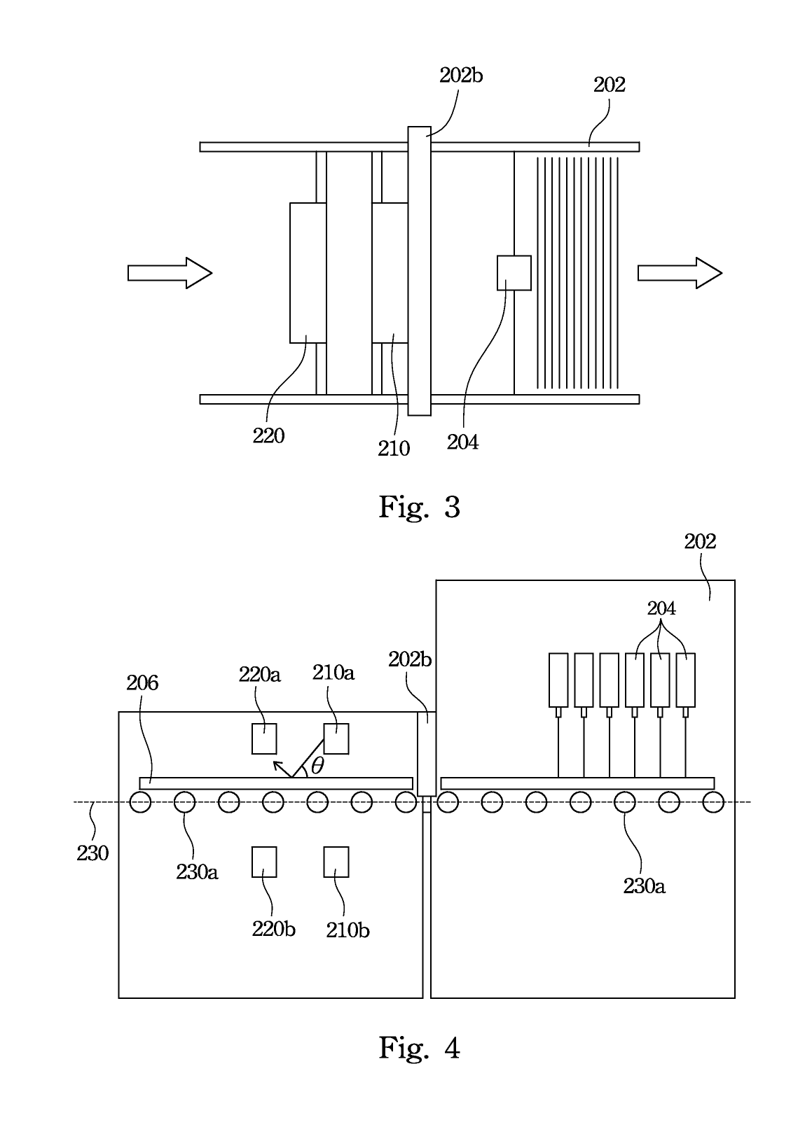

FIG. 3 illustrates a top view of a laser scribing apparatus with air cleaning and air cooling function according to one embodiment of this invention, and FIG. 4 illustrates a side view of the laser scribing apparatus as illustrated in FIG. 3. In order to prevent high-temperature glass substrate and particles on the glass substrate from interfering the laser scribing process, an air cleaning and air cooling mechanism is installed adjacent to an input door 202b of the chamber 202. In particular, at least a pair of air knife device and air vacuum device are installed outside the chamber 202 and adjacent to the input door 202b. The air knife device is to force the particles away from the solar panel while the air vacuum device is to collect the particles. Besides, the airflow can dissipate the heat on the solar panel. As illustrated in FIG. 4, a pair of air knife device 210a and air vacuum device 220a is located above a transferring line 230, which consists of rollers 230a, and another pair of air knife device 210b and air vacuum device 220b is located under the transferring line 230. The air knife device 210a and air vacuum device 220a is to air clean and air cool an upper surface of a solar panel 206 while the air knife device 210b and air vacuum device 220b is to air clean and air cool a lower surface of the solar panel 206. The air knife device, e.g. 210a, can blow air stream along a direction that has an included angle θ ranging from about 30 degrees to about 45 degrees between the direction and the solar panel, e.g. 206. In this embodiment, the air knife device (e.g. 210a or 210b) is closer to the input door 202b than the air vacuum device (e.g. 220a or 220b) is. Besides, the air knife device (e.g. 210a) and the air vacuum device (e.g. 220a) are located substantially equidistant from the transferring line 230.

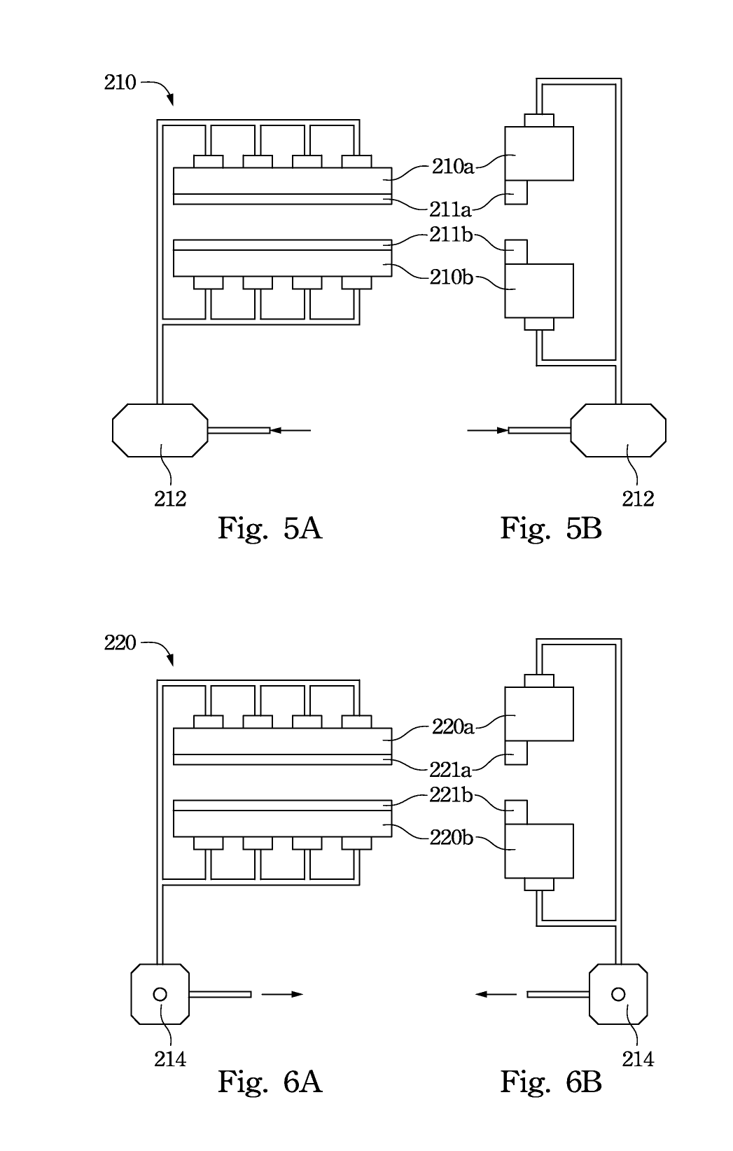

FIG. 5A illustrates a front view of an air knife assembly according to one embodiment of this invention, and FIG. 5B illustrates a side view of the air knife assembly as illustrated in FIG. 5A. The air knife assembly 210 includes the air knife device 210a and the air knife device 210b, which both are air-supplied by an air blower 212. Each air knife device (210a or 210b) has several air knife nozzles (211a or 211b), which are positioned in parallel to cover a width of the solar panel, e.g. 106 or 206.

FIG. 6A illustrates a front view of an air vacuum assembly according to one embodiment of this invention, and FIG. 6B illustrates a side view of the air vacuum assembly as illustrated in FIG. 6A. The vacuum assembly 220 includes the air vacuum device 220a and the air vacuum device 220b, which both are vacuumed by an air pump 214. Each air vacuum device (220a or 220b) has several air vacuum valves (221a or 221b), which are positioned in parallel to cover a width of the solar panel, e.g. 106 or 206.

According to the discussed embodiments, at least a pair of air knife device and air vacuum device is installed adjacent to the input door of the laser-scribing chamber to air clean and air cool the solar panel in advance, thereby increasing the laser scribing precision and enhancing the throughout yield.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A laser scribing apparatus comprising:
a chamber comprising an input door and an output door, through which a processing target is input and output respectively;
a transferring line for transferring the processing target through the input door and output door;
a laser head disposed within the chamber; and
a first pair of air vacuum device and air knife device disposed outside the chamber and adjacent to the input door for cleaning and cooling the processing target.

2. The laser scribing apparatus of claim 1, wherein the first pair of air vacuum device and air knife device are disposed above the transferring line.

3. The laser scribing apparatus of claim 1, wherein the first pair of air vacuum device and air knife device are disposed under the transferring line.

4. The laser scribing apparatus of claim 1 further comprising a second pair of air vacuum device and air knife device, wherein the first pair of air vacuum device and air knife device are disposed above the transferring line, and the second pair of air vacuum device and air knife device are disposed under the transferring line.

5. The laser scribing apparatus of claim 1, wherein the laser head is disposed above the transferring line.

6. The laser scribing apparatus of claim 1, wherein the laser head is disposed under the transferring line.

7. The laser scribing apparatus of claim 1, wherein the air knife device is closer to the input door than the air vacuum device is.

8. The laser scribing apparatus of claim 1, wherein the air knife device and the air vacuum device are equidistant from the transferring line.

9. The laser scribing apparatus of claim 1, wherein the transferring line is disposed aligned with the input door and output door.

10. The laser scribing apparatus of claim 1, wherein the transferring line comprises a plurality of rollers.

11. A laser scribing process for the solar panel comprising:
air cleaning and air cooling a solar panel comprising a plurality of photovoltaic cells before performing a laser scribing process on the solar panel.

12. The laser scribing process of claim 11, further comprising:
using a pair of air vacuum device and air knife device for air cleaning and air cooling the solar panel.

13. The laser scribing process of claim 12, further comprising:
using a chamber comprising an input door and an output door, through which the solar panel is input and output respectively, for performing the laser scribing process on the solar panel.

14. The laser scribing process of claim 13, further comprising:
using a transferring line for transferring the solar panel through the input door and output door.

15. The laser scribing process of claim 14, further comprising:
using the air knife device blow air stream along a direction that has an included angle ranging from about 30 degrees to 45 degrees between the direction and the solar panel.

16. The laser scribing process of claim 14, further comprising:
using a first pair of air vacuum device and air knife device disposed above transferring line for air cleaning and air cooling the solar panel; and
using a second pair of air vacuum device and air knife device disposed under transferring line for air cleaning and air cooling the solar panel.

17. The laser scribing process of claim 11, further comprising:
using a first pair of air vacuum device and air knife device for air cleaning and air cooling a surface of the solar panel; and
using a second pair of air vacuum device and air knife device for air cleaning and air cooling an opposite surface of the solar panel.

18. The laser scribing process of claim 11, further comprising:
using the air knife device to force particles away from the solar panel; and
using the air vacuum device to collect the particles.
